(19) United States
(12) Patent Application Publication
(10) Pub. No.: US 2015/0208670 A1
(43) Pub. Date: Jul. 30, 2015

(54) DEVICE FOR MIXING AND/OR KNEADING FOOD PRODUCTS

(71) Applicant: SOTEC BEHEER TWEE B.V., Maastricht (NL)

(72) Inventor: Gillis Ann Maria Victor Lekner, Berg En Terblijt (NL)

(21) Appl. No.: 14/427,884

(22) PCT Filed: Sep. 13, 2013
(86) PCT No.: PCT/NL2013/050661

§ 371 Date: Mar. 12, 2015

(30) Foreign Application Priority Data
Sep. 14, 2012 (NL) 2009463

(51) Int. Cl. A21C 1/06; B01F 7/00

(52) U.S. Cl. CPC A21C 1/06; B01F 7/00416; B01F 2215/0011

(57) ABSTRACT

The invention relates to a device for mixing and/or kneading food products. The device is provided with at least one container having a container inlet and, spaced therefrom, a container outlet, and at least one rotary shaft extending substantially in the longitudinal direction of the container between the container inlet and the container outlet. The shaft is provided with a mixing and/or kneading element for mixing and/or kneading the food products substantially in a continuous manner. In the container, an operative space is formed between the container inlet and the container outlet, where mixing and/or kneading of the food products is to take place. According to the invention, the device is provided with pressure means for adjusting the pressure in the operative space, and with pushing means for at least partially forming a sealing wall of the operative space with the food products to be mixed and/or kneaded.

The invention relates to a device for mixing and/or kneading food products, in particular foodstuffs, according to the preamble of claim 1.

Such a device is generally known, it is for example used for kneading bread dough. From EP 0 729 303 there is for example known a tub-shaped container which is open at the upper side. Two identical counter-rotating shafts are disposed in the container, which shafts are fitted with tools in the form of U-shaped bracket elements. The dough that is present in the container is kneaded by means of said bracket elements. In the container, the dough is transported from the inlet to the outlet in use. The quality of the kneaded dough obtained by means of the device leaves room for improvement.

Changing the pressure during kneading may have an advantageous effect on the quality of the mixed and/or kneaded product. In the case of food products, in particular foodstuffs such as dough, reducing the pressure during kneading will result in a smaller cell structure, so that the end product (for example bread) will contain fewer holes. Furthermore, the dough will stick to a relatively smaller extent. In addition to that, the volume of the product will increase, and more water can be added to the foodstuff to be kneaded. In the case of dough for white bread, for example, the end product will have a whiter colour.

Reducing the pressure of foodstuffs to be kneaded already takes place in the prior art in so-called batch processes, in which dough to be kneaded is introduced into a fully sealable container, the container is closed, the pressure is reduced and the dough is kneaded. After kneading, the container is opened and the kneaded dough is removed from the container.

Kneading food products, in particular foodstuffs, more in particular bread, in a continuous process at an adjusted pressure constitutes a challenge. The use of an underpressure in transporting food products is a technique that is known per se, for example from GB 412 779 A, CH 389 531 A, or U.S. Pat. No. 2,712,799 A. It has been found, however, that in a continuous process, in particular for kneading bread dough, it is very difficult to adequately seal the operative space so as to thus maintain the adjusted pressure. It has furthermore become apparent to the inventor that conventional seals according to the prior art do not function properly and that they are difficult to clean, which is undesirable for reasons of hygiene in the production of foods, in particular foodstuffs.

Accordingly it is an object of the present invention to provide an improved device by means of which food products can be kneaded, in particular at an elevated or a reduced pressure.

In order to achieve that object, the present invention provides a device of the kind described in the introduction, which is characterised by the characterising part of claim 1.

The device according to the present invention is provided with pressure means for changing the pressure in the operative space. The pressure means comprise, for example, a pump unit connected to the operative space by means of which a reduced pressure, for example a vacuum, can be generated in the operative space. The inventor has surprisingly recognised that an adequate seal can be realised in a very simple and efficient manner by making use of the very foodstuff to be mixed and/or kneaded. According to the invention, pushing means are used for that purpose, which pushing means generate a pushing force on the product on an upstream and/or downstream side of the operative space, so that a sealing wall of the operative space is obtained with the product to be mixed/kneaded. The inner wall of the container and the product to be mixed/and or kneaded together form the sealing walls of the operative are, in which an elevated or a reduced pressure can thus be generated.

According to the present invention, the distance between a radially outward point on the mixing and/or kneading element and the inner side of the container, seen in cross-sectional view of the cylinder, varies during rotation of the shaft. This distance variation makes it possible to use the inner side of the container for influencing the flow of the food products to be kneaded. The flow of the foodstuff can thus take place more homogeneously, so that a barrier against airflows is obtained.

The distance between the point on the mixing and/or kneading element and the inner side of the container is smaller near a point above the shaft than near a point below the shaft, at least in an operative condition of the device according to the present invention. Consequently, a constriction between the inner wall of the container and the mixing and/or kneading element takes place in upward direction. In one embodiment, for example, the cross-section of the container is essentially unround, in particular oval, so that a constriction is present above the shaft.

At the location of the constriction the foodstuff to be kneaded will be subjected to a greater shear stress, as a result of which the foodstuff is pushed further upward. This means that in an operative condition of the device the foodstuff being pushed up effectively seals the operative space at the upper side of the container, which is normally freely accessible (for example for maintenance and/or cleaning). The container is thus configured so that it also functions as a pushing means.

Because the upper side of the container is freely accessible, the container is easy to clean after use. During use, however, the foodstuff to be kneaded seals the freely accessible container, so that mixing and/or kneading can nevertheless take place at an underpressure.

From the above it is clear that the pushing means and the pressure means, and the shape of the container, make it possible to successfully make use of an adjusted, preferably reduced, pressure also in a continuous kneading process, which is not possible with the devices currently known to the inventor. The adjusted pressure will lead to an improved quality of the kneaded dough. The object of the invention is thus achieved.

Advantageous embodiments of the invention will be discussed in more detail hereinafter.

In one embodiment, the cross-section of the container may be essentially unround, in particular oval. Such a shape is relatively easy to manufacture.

In one embodiment, the pushing means are located near an upstream and/or near a downstream part of the operative space. A pushing means located near the upstream part makes it possible to form a sealing wall between the container inlet and the operative space. A pushing means located near the upstream part provides a sealing wall between the container outlet and the operative space. At places where the supply and/or discharge of food products take(s) place continuously there is a greater chance of airflows from and to the operative space. At said places, air may unintentionally an escape from the operative space or, on the contrary, be carried along. Consequently an adequate seal is required at those places. The pushing means ensures that an adequate seal formed by the food products themselves is obtained at said places. This reduces the risk of undesirable supply or discharge of air.

In a very advantageous embodiment, the pushing means comprises a local constriction in the container. The constriction is selected so that the product is subjected to a pushing force, resulting in the formation of a sealing wall of the operative space. The local constriction can be realised in a simple manner. A constriction is furthermore easy to clean.

The local constriction can be realised in a very efficient and simple manner if use is made of a blocking plate which extends substantially in radial direction from the inner side of the container until the mixing and/or kneading element. The blocking plate can be regarded as a radial flange, which causes the product to be pushed forward. The blocking plate is configured so that it forms a physical edge, through which air cannot pass, such that the adjusted pressure in the operative space can be maintained.

In one embodiment, the pushing means comprise a filling unit of a further processing device, which is placed directly on the container outlet. According to the prior art, the kneaded dough is placed on a conveyor belt from the container outlet. Said conveyor belt slopes further upwards, toward a filling hopper of a further processing unit, such as a portioning unit or a distributing unit. By connecting the filling unit, such as the filling hopper, directly to the outlet of the kneading device, it becomes possible to use the filling unit as a pushing means, so that the kneaded foodstuff present in the filling unit can be used to form a sealing wall for the operative space. The filling unit is to that end connected to the outlet of the kneading device in such a manner that the supply or discharge of air to or from the operative space is prevented. The foodstuff present in the filling unit thus simply forms the sealing wall for maintaining the reduced or elevated pressure in the operative space.

It is noted that connecting the filling unit of the further processing device directly to the container outlet of the mixing and/or kneading device can also be used independently, without using pressure means and pushing means. This makes it possible to realise a compact system, and the conveyor belt can be left out, making it possible to work in a more compact and more hygienic manner. According to one aspect, a device for mixing and/or kneading food products, in particular foodstuffs, is therefore provided in which the device is provided with at least one container having a container inlet and, spaced therefrom, a container outlet, as well as at least one rotary shaft extending substantially in the longitudinal direction of the container between the container inlet and the container outlet, which shaft is provided with a mixing and/or kneading element for mixing and/or kneading the food products substantially in a continuous manner, wherein the mixing and/or kneading element comprises a bar which helically surrounds the shaft, wherein the device is further designed for transporting the food products from the container inlet to the container outlet, wherein an operative space is formed between the container inlet and the container outlet in the container, where mixing and/or kneading of the food products is to take place, which device is characterised in that a filling unit of a further processing device is connected directly to the outlet. This direct connection obviates the need for the upwardly sloping conveyor belt already described in the foregoing, which saves space. Furthermore, a closed unit is obtained, which is more hygienic. Undesirable contaminations of the kneaded mixture, for example by dust particles or other particles that fall on the kneaded foodstuff during transport on the open conveyor belt to the portioning device, are thus prevented. The applicant reserves the right to apply for separate protection for this embodiment, related and/or other embodiments, for example by means of a divisional application.

It is noted that a constriction according to the present invention as described above is advantageous also if no pressure means and sealing means are used. According to one aspect, there is thus provided a device for mixing and/or kneading food products, in particular foodstuffs, in which the device is provided with at least one container having a container inlet and, spaced therefrom, a container outlet, as well as at least one rotary shaft extending substantially in the longitudinal direction of the container between the container inlet and the container outlet, which shaft is provided with a mixing and/or kneading element for mixing and/or kneading the food products substantially in a continuous manner, wherein the mixing and/or kneading element comprises a bar which helically surrounds the shaft, wherein the device is further designed for transporting the food products from the container inlet to the container outlet, wherein an operative space is formed between the container inlet and the container outlet in the container, where mixing and/or kneading of the food products is to take place, wherein the device is characterised in that, seen in cross-sectional view of the cylinder, the distance between a radially outward point on the mixing and/or kneading element and the inner side of the container varies during rotation of the shaft. The applicant reserves the right to apply for separate protection for this embodiment, related and/or other embodiments, for example by means of a divisional application.

According to one embodiment, the tool comprises a bar which helically surrounds the shaft, wherein a part of the bar located near the outlet makes a smaller angle with the rotary shaft than an upstream part of the bar. The bar that helically surrounds the shaft forms the mixing and/or kneading element. The mixing and/or kneading element is in large part disposed at an angle relative to the rotary shaft. Because of said angle, the foodstuff to be mixed and/or kneaded is transported in downstream direction from the container inlet to the container outlet. In this embodiment a smaller angle is used along a substantial part of the container near the outlet, such that the conveying speed decreases near the outlet. In a continuous process, this generates a certain pushing force on the mixed and/or kneaded material. The foodstuff being pushed forward thus effectively seals the operative space, making it possible to maintain the adjusted pressure in the operative space.

It is noted that the use of such a change in the angle of the bar is also possible without making use of the pressure means and the sealing means. According to one aspect, a device for mixing and/or kneading food products, in particular foodstuffs, is therefore provided in which the device is provided with at least one container having a container inlet and, spaced therefrom, a container outlet, as well as at least one rotary shaft extending substantially in the longitudinal direction of the container between the container inlet and the container outlet, which shaft is provided with a mixing and/or kneading element for mixing and/or kneading the food products in a substantially continuous manner, which mixing and/or kneading element comprises a bar which helically surrounds the shaft, wherein the device is also designed for transporting the food products from the container inlet to the container outlet, wherein an operative space is formed in the container between the container inlet and the container outlet, where mixing and/or kneading of the food products is to take place, wherein the device is characterised in that a part of the bar located near the container outlet makes a smaller angle with the rotary shaft than an upstream part of the bar. The smaller angle makes it possible to realise a certain degree of pressure build-up, so that the kneading tool is used in an efficient manner.

In one embodiment, the bar makes an angle of less than 7 degrees, preferably more than −3 degrees, with the rotary shaft near the outlet. The angle can be selected in dependence on the desired pushing effect. It is noted in that regard that the angle may also be a negative angle, causing a counterflow of the product to be mixed and/or kneaded, as it were, so that a greater pushing effect can be achieved. The angle is selected so that continuous transport will actually take place.

In a very advantageous embodiment, the bar extends substantially parallel to the shaft along some distance near the outlet. This has been found to be very efficient.

It is preferable if the pressure means are designed for generating an underpressure in the operative space. The pressure means may consist of a vacuum pump, for example.

The device preferably comprises a mixing tool provided between the operative space and the container inlet for initial mixing of the food products to be mixed and/or kneaded. Said initial mixing can take place at a normal pressure, after which the subsequent mixing and/or kneading can take place at an adjusted pressure. The mixing tool is preferably connected to the rotary shaft by means of spacers.

According to one aspect of the invention there is provided a method for mixing and/or kneading for products, in particular foodstuffs, using a device according to the invention, which method comprises the steps of
conveying the food products to be mixed and/or kneaded from the container inlet, via the operative space, to the downstream container outlet;
mixing and/or kneading the food products being supplied at the location of the operative space.

According to the invention, the method is characterised in that mixing and/or kneading takes place at a pressure different from the ambient pressure, and in that the methods comprises the step of at least partially forming a sealing wall of the operative space from the food products to be mixed and/or kneaded. As already explained in the foregoing, the inventor has found that it is precisely the material to be kneaded that forms a very efficient barrier against air flows from and to the operative space. This applies in any case as regards the food products to be kneaded, which have a dough-like structure and substance during kneading, and which have a relatively high viscosity, such as bread dough and other dough materials, for example. By using the food products as a seal, it becomes possible in a simple and efficient manner to knead the food products at an elevated or a reduced pressure.

Supplying the food products to be kneaded takes place in a substantially continuous manner. A continuous mixing and/or kneading process is realised, in which the supplying and discharging of food products take place simultaneously.

As already described in the foregoing, it is conceivable that an initial mixing process will take place prior to the step of mixing and/or kneading. In one embodiment, the method therefore comprises the step of mixing the food products to be kneaded at a location downstream of the container inlet and upstream of the kneading location.

The invention will now be explained in more detail by means of a description of a preferred embodiment of a device and a method according to the invention, in which reference is made to the following figures, in which:

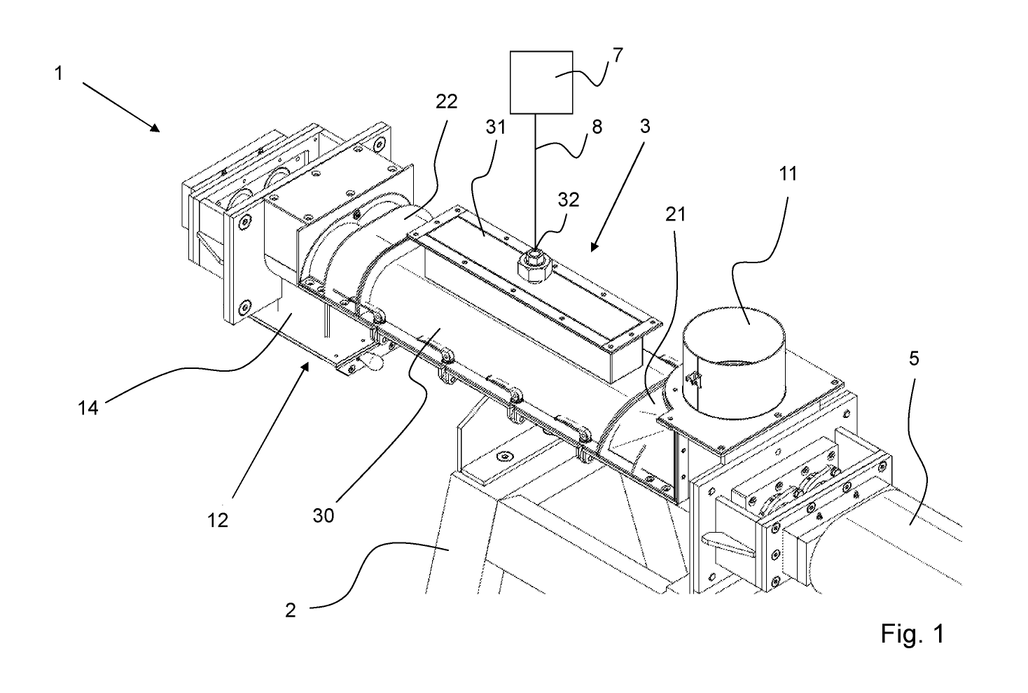

FIG. 1 is a perspective view of a device for mixing and/or kneading food products, in particular foodstuffs, according to an embodiment of the present invention;

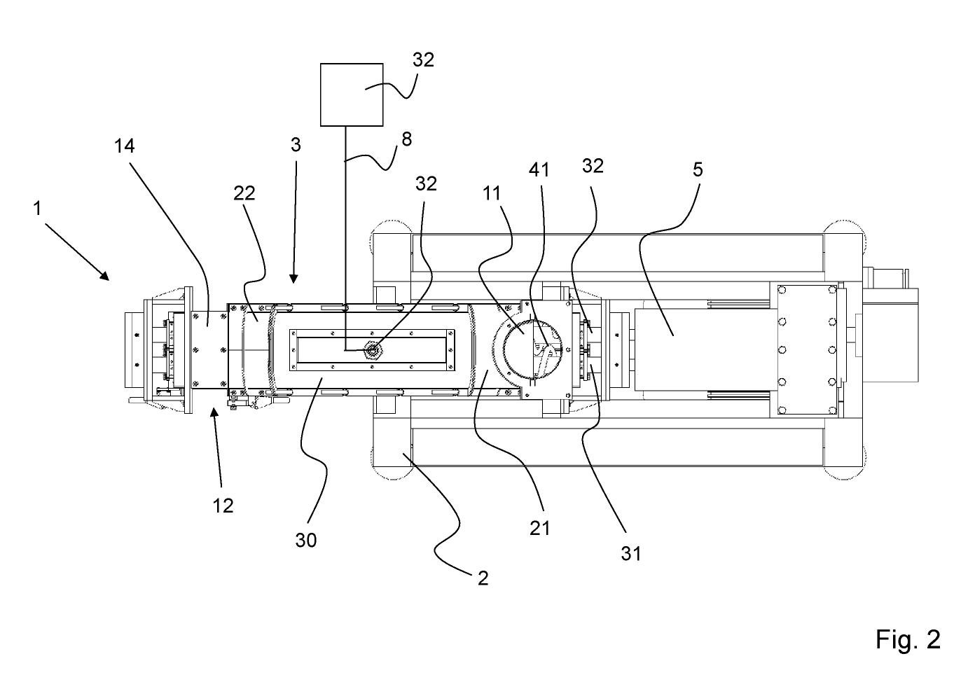

FIG. 2 is a top plan view of the device shown in FIG. 1;

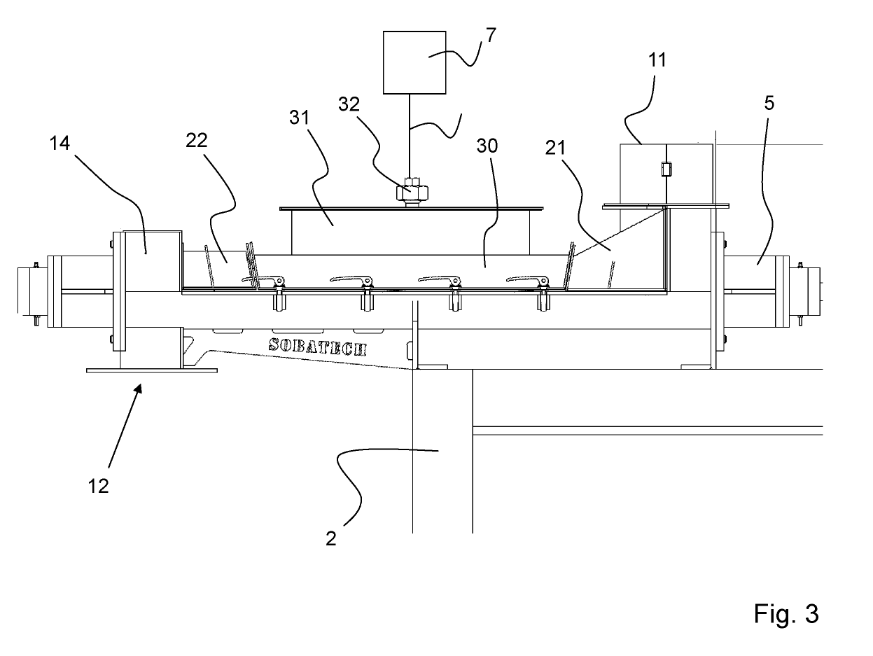

FIG. 3 is a side view of the device shown in FIG. 1;

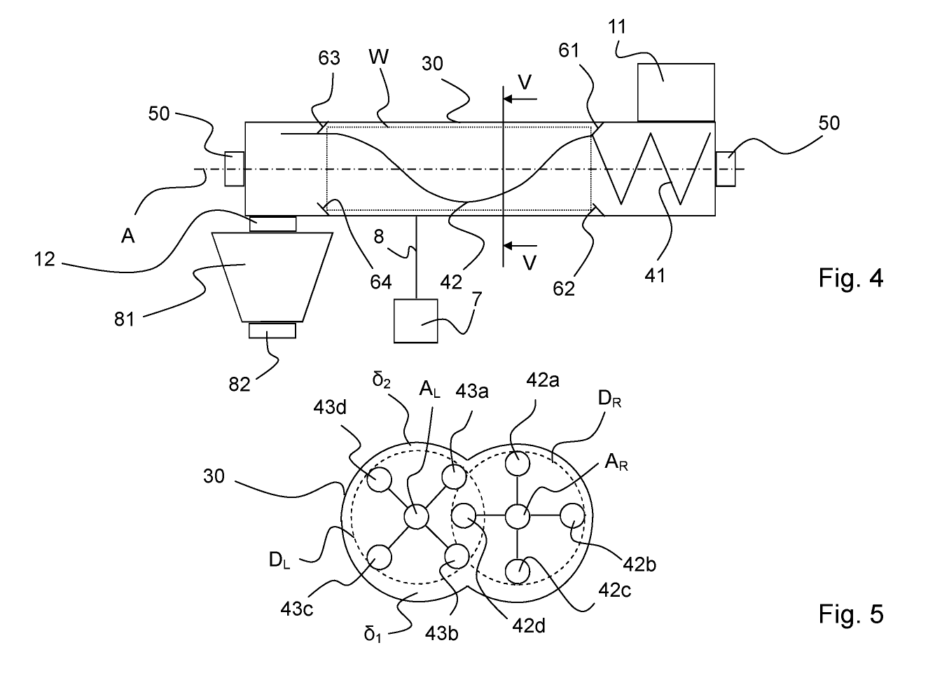

FIG. 4 is a schematic view of the device according to an embodiment of the present invention;

FIG. 5 is a schematic cross-sectional view of the device along the line V-V in FIG. 4.

FIG. 1 shows in perspective view a device 1 according to the present invention, by means of which food products, such as foodstuffs (in particular dough-like products such as bread dough) can be mixed and/or kneaded. The structure of such a device is known per se to the skilled person, for example from NL 1029273, and consequently only a compact description will be given herein.

The device 1 comprises a frame 2, on which a container 3 is disposed. The container 3 comprises a container housing 30. Disposed inside the container housing are mixing and/or kneading elements (not shown in FIG. 1), as will be explained in more detail yet, but as also known to the skilled person, for example from the aforesaid NL 1029273. The mixing and/or kneading elements can be rotatably driven via driving means 5 in a manner which is known per se. The device 1 comprises a container inlet 11 connected to the container 3, via which the products to be mixed and/or kneaded can be introduced into the interior of the container housing 30. Downstream thereof, the container housing 30 is provided with a container outlet 12, via which the mixed and/or kneaded product leaves the device 1 again.

The container housing 30 is provided with an attachment 31 at an upper side thereof, which attachment comprises a connection 32, via which a pipe 8 is connected to pressure means 7. The pressure means 7 can be used for adjusting the pressure in the interior of the container housing 30 relative to the ambient pressure. The pressure means 7 may comprise a vacuum pump unit, for example, for decreasing the pressure, although it is also conceivable to increase the pressure.

In order to maintain the pressure in the interior of the container housing 30, i.e. maintain the adjusted pressure relative to the ambient pressure, the device comprises pushing means 21, 22, 14. The pushing means 21, 22, 14 are designed to seal the operative space of the container 3, i.e. the area where the product to be mixed and/or kneaded is processed under an adjusted pressure. According to the invention, the operative space is sealed by means of the products to be mixed and/or kneaded. This may also imply that the already partially or fully mixed and/or kneaded product is used for sealing the operative space. The container housing 30 thus forms a circumferential wall of the operative space, as it were, and the product preferably forms a bottom and a cover of the operative space, such that a closed unit is formed.

FIG. 2 shows the device 1 of FIG. 1 in top plan view, and FIG. 3 shows the device 1 in side view. Like parts are indicated by the same numerals. As the figures clearly show, the container 3 is partially disposed on the frame 2, with the driving means 5 being more or less fully supported on the frame 2. As is furthermore shown at the location of the container inlet 11 (see FIG. 2), the container inlet 11 provides direct access to a mixing and/or kneading element 41. Said mixing and/or kneading element 41 is arranged around a shaft 31. Said shaft 31 is driven by the driving means 5. Also provided is a second shaft with a second mixing and/or kneading element. Said second element lies in the same horizontal plane as the first element and extends parallel thereto.

In the illustrated embodiment, the part of the container 3 that is indicated at 30 forms the operative space, in which an underpressure or an overpressure can be generated, using the pressure means 7. Upstream and downstream thereof, connecting parts 21, 22 are provided. The connecting parts 21, 22 are preferably configured such that they form pushing means for forming a sealing wall of the operative space with the products.

The connecting part 21 is to that end conical in shape (see FIG. 3), such that, seen in the direction of flow, the through-flow area decreases. The smaller through-flow area provides a pushing effect, so that an accumulation of the product is obtained in a natural manner and a sealing wall is thus formed. The second connecting part 22 provides a pushing effect in a slightly different manner, for example in that the through-flow area is reduced by means of a flanged edge that extends toward the interior of the container 3. Such an embodiment is shown in FIG. 4, for example.

FIG. 4 shows a schematic overview of a device 1 according to the present invention. Schematically seen, the device 1 comprises a container 3 with a container housing 30, which is provided with a container inlet 11 at an upstream location and a container outlet 12 at a downstream location. A central shaft 50 is rotatably disposed within the container 30.

Mounted on the shaft 50 is an initial mixing element 41, with a kneading element 42 provided downstream thereof. Pushing means 61, 62 in the form of a blocking plate 61, 62 are provided at the transition from the mixing element 41 to the kneading element 42. Said pushing means function as a sort of flange and effect an accumulation of the product. Blocking plates 63, 64 are provided also at the downstream end of the kneading element 42. The blocking plates may extend over the entire circumference of the container. As the figure further shows, the end portion of the kneading element 42 makes a smaller angle with the rotary shaft 50 than an upstream portion of the bar 42. Near the outlet, the end portion of the bar 42 preferably makes an angle of less than 7 degrees, preferably more than −3 degrees, with the rotary shaft 50. In the illustrated embodiment, the bar 42 preferably extends substantially parallel to the shaft 50 in a part of the container near the container outlet.

In FIG. 4 another pushing means 81 in the form of a hopper 81 is disposed near the container outlet 12, at the bottom side of which hopper a valve 82 is provided. When the valve 82 is closed, the hopper can be filled, such that the product will form a sealing wall. Said hopper 81 can thus also be used as a pushing means. In a preferred embodiment, the hopper 81 forms part of a further processing device for processing the product, such as a portioning device or a distributing device.

FIG. 5, to conclude, shows a sectional view of the device along the line V-V in FIG. 4. The figure shows a section of the housing 30 of the container. The view is a binocular-like sectional view, as known to the skilled person. Each of the circles comprises a rotary shaft AL and AR. Each shaft is provided with a number of helically extending bars 42a-d and 43a-d. Said bars describe a path DL and DR, respectively, during their rotation. As shown in FIG. 5, the distance between a radially outward point on the mixing and/or kneading element and the inner side of the container varies during rotation of the shaft AL, AR. At the bottom side, the distance 61 is relatively large, whilst at the upper side the distance 62 is relatively small. The cross-section of the container 30 is substantially unround, in particular oval (in fact a double oval shape). Such a configuration provides the pushing effect on the product, thereby realising an effective seal.

The skilled person will appreciate that in the foregoing the invention has been described on the basis of a few possible embodiments, which are preferred. The invention is not limited to these embodiments, however. Many possible equivalent modifications are conceivable within the framework of the invention, which modifications may fall within the scope of the appended claims.

1. A device for mixing and/or kneading food products, in particular foodstuffs, in which the device is provided with at least one container having a container inlet and, spaced therefrom, a container outlet, as well as at least one rotary shaft extending substantially in the longitudinal direction of the container between the container inlet and the container outlet, which shaft is provided with a mixing and/or kneading element for mixing and/or kneading the food products substantially in a continuous manner, wherein the mixing and/or kneading element comprises a bar which helically surrounds the shaft, spaced therefrom by spacers, wherein the device is further designed for transporting the food products from the container inlet to the container outlet, wherein an operative space is formed between the container inlet and the container outlet in the container, where mixing and/or kneading of the food products is to take place, wherein the device is provided with pressure means, such as a vacuum pump unit, for adjusting the pressure in the operative space, and also with pushing means for at least partially forming a sealing wall of the operative space with the food products to be mixed and/or kneaded so as to thus maintain the pressure in the operative space, characterised in that, seen in cross-sectional view of the cylinder, the distance between a radially outward point on the mixing and/or kneading element and the inner side of the container varies during rotation of the shaft, wherein the distance between the point on the mixing and/or kneading element and the inner side of the container is smaller near a point above the shaft than near a point below the shaft, at least in an operative condition of the device.

2. A device according to claim 1, wherein the cross-section of the container is essentially unround, in particular oval.

3. A device according to claim 1, wherein the pushing means are located near an upstream and/or near a downstream part of the operative space.

4. A device according to claim 1, wherein the pushing means comprise a local constriction in the container.

5. A device according to claim 4, wherein the local constriction is formed by a blocking plate which extends from the inner side of the container, substantially in the radial direction thereof, essentially until a radially outward part of the mixing and/or kneading element.

6. A device according to claim 1, wherein the pushing means comprise a filling unit of a further processing device, which is placed directly on the container outlet.

7. A device according to claim 1, wherein a part of the bar located near the outlet makes a smaller angle with the rotary shaft than an upstream part of the bar.

8. A device according to claim 7, wherein the bar makes an angle of less than 7 degrees, preferably more than −3 degrees, with the rotary shaft near the outlet.

9. A device according to claim 8, wherein the bar extends substantially parallel to the shaft over some distance in a part of the container that is located near the outlet.

10. A device according to claim 1, wherein the pressure means are designed for generating an underpressure in the operative space.

11. A device according to claim 1, wherein the device comprises a mixing tool provided between the operative space and the container inlet for initial mixing of the food products to be mixed and/or kneaded.

12. A device according to claim 11, wherein the mixing tool is attached to the rotary shaft by means of spacers.
